(19) United States
(12) Patent Application Publication
(10) Pub. No.: US 2022/0319335 A1
(43) Pub. Date: Oct. 6, 2022

(54) VEHICLE SCHEDULING METHOD, SYSTEM AND MAIN CONTROL DEVICE

(71) Applicant: SHENZHEN ANTU AUTONOMOUS DRIVING TECHNOLOGIES LTD., Shenzhen (CN)

(72) Inventor: YANLAN LIU, SHENZHEN (CN)

(21) Appl. No.: 17/708,011

(22) Filed: Mar. 30, 2022

(30) Foreign Application Priority Data
Mar. 30, 2021 (CN) 2021103436455

(51) Int. Cl. G08G 1/00; B60W 60/00; G01C 21/34; G06Q 10/06

(52) U.S. Cl. CPC G08G 1/202; B60W 60/00253; G01C 21/3484; G01C 21/3492; G06Q 10/06314; B60W 2556/40

(57) ABSTRACT

A vehicle scheduling method is provided. The method comprises steps of: obtaining reservation information that includes a starting position, an end position, and a departure time; planning a number of first paths according to the starting position and the end position; determining whether at least one of the first paths is fully displayed on high-precision map; when the first paths are not fully displayed on the high-precision map, dispatching manual driving vehicles; and when at least one of the first paths is fully displayed on the high-precision map, dispatching autonomous driving vehicles or the manual driving vehicles according to corresponding scheduling rules selected by the departure time.

### CROSS REFERENCE TO RELATED APPLICATION

This non-provisional patent application claims priority under 35 U.S.C. § 119 from Chinese Patent Application No. 202110343645.5 filed on Mar. 30, 2021, the entire content of which is incorporated herein by reference.

### TECHNICAL FIELD

The disclosure relates to the field of intelligent traffic, and in particular to a vehicle scheduling method and a system thereof, and a main control device.

### BACKGROUND

Through the Internet vehicle call platform, drivers can obtain the taxi-hailing needs of users in time and take orders according to their wishes, so as to save the communication cost between drivers and users, optimize the taxi-hailing experience of users, and maximize the resources and time of both parties.

With the popularity of autonomous driving vehicles, it has become a new mode of transportation to operate the autonomous driving vehicles as taxis. How to maximize the autonomous driving vehicles used as taxis to meet the needs of different passengers, and how to make the scheduling method of the autonomous driving vehicles more reasonable are urgent problem to be solved.

### SUMMARY

The disclosure provides a vehicle scheduling method and a system thereof, and a main control device, which makes the scheduling of autonomous driving vehicles more reasonable.

A first aspect of the disclosure provides a vehicle scheduling method, and the vehicle scheduling method includes the steps of: obtaining reservation information that includes a starting position, an end position, and a departure time; planning a number of first paths according to the starting position and the end position; determining whether at least one of the first paths is fully displayed on high-precision map; when the first paths are not fully displayed on the high-precision map, dispatching manual driving vehicles; and when at least one of the first paths is fully displayed on the high-precision map, dispatching autonomous driving vehicles or the manual driving vehicles according to corresponding scheduling rules selected by the departure time.

A second aspect of the disclosure provides a main control device, the main control device comprises: a memory configured to store program instructions and a processor configured to execute the program instructions to perform a vehicle scheduling method, the method comprise: obtaining reservation information that includes a starting position, an end position, and a departure time; planning a number of first paths according to the starting position and the end position; determining whether at least one of the first paths is fully displayed on high-precision map; when the first paths are not fully displayed on the high-precision map, dispatching manual driving vehicles; and when at least one of the first paths is fully displayed on the high-precision map, dispatching autonomous driving vehicles or the manual driving vehicles according to corresponding scheduling rules selected by the departure time.

A third aspect of the disclosure provides vehicle scheduling system, the vehicle scheduling system comprises: manual driving vehicles, autonomous driving vehicles, and a vehicle scheduling platform, the vehicle scheduling platform comprises a main control device. The main control device comprises: a memory configured to store program instructions and a processor configured to execute the program instructions to perform a vehicle scheduling method, the method comprise: obtaining reservation information that includes a starting position, an end position, and a departure time; planning a number of first paths according to the starting position and the end position; determining whether at least one of the first paths is fully displayed on high-precision map; when the first paths are not fully displayed on the high-precision map, dispatching manual driving vehicles; and when at least one of the first paths is fully displayed on the high-precision map, dispatching autonomous driving vehicles or the manual driving vehicles according to corresponding scheduling rules selected by the departure time

The vehicle scheduling method and system, and the main control device plan a number of first paths according to the starting position and the end position of the reservation information, and select the corresponding scheduling rules to dispatch the manual driving vehicles or the autonomous driving vehicles by determining whether at least one of the first paths is fully displayed on the high-precision map and the departure time. Dispatching vehicles according to the corresponding scheduling rules can makes scheduling of vehicles more reasonable, dispatch vehicles with maximum efficiency and improve the utilization rate of vehicles.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a flow diagram of a vehicle scheduling method in accordance with a first embodiment.

FIG. 2 illustrates a first sub flow diagram of a vehicle scheduling method in accordance with the first embodiment.

FIG. 3 illustrates a second sub flow diagram of a vehicle scheduling method in accordance with the first embodiment.

FIG. 4 illustrates a third sub flow diagram of a vehicle scheduling method in accordance with the first embodiment.

FIG. 5 illustrates a sub flow diagram of a vehicle scheduling method in accordance with a second embodiment.

FIG. 6 illustrates a sub flow diagram of a vehicle scheduling method in accordance with a third embodiment.

FIG. 7 illustrates a sub flow diagram of a vehicle scheduling method in accordance with a fourth embodiment.

FIG. 8 illustrates a fourth sub flow diagram of a vehicle scheduling method in accordance with the first embodiment.

FIG. 9 illustrates a fifth sub flow diagram of a vehicle scheduling method in accordance with the first embodiment.

FIG. 10 illustrates a sixth sub flow diagram of a vehicle scheduling method in accordance with the first embodiment.

FIG. 11 illustrates a seventh sub flow diagram of a vehicle scheduling method in accordance with the first embodiment.

FIG. 12 illustrates a sub flow diagram of a vehicle scheduling method in accordance with a fifth embodiment.

FIG. 13 illustrates a first schematic diagram of a vehicle scheduling method in accordance with the first embodiment.

FIG. 14 illustrates a second schematic diagram of a vehicle scheduling method in accordance with the first embodiment.

FIG. 15 illustrates a third schematic diagram of a vehicle scheduling method in accordance with the first embodiment.

FIG. 16 illustrates a fourth schematic diagram of a vehicle scheduling method in accordance with the first embodiment.

FIG. 17 illustrates a schematic diagram of a vehicle scheduling method in accordance with the second embodiment.

FIG. 18 illustrates a schematic diagram of a main control device in accordance with an embodiment.

FIG. 19 illustrates a schematic diagram of a vehicle scheduling system in accordance with the embodiment.

### DETAILED DESCRIPTION OF THE EMBODIMENTS

In order to make purpose, technical solution and advantages of the disclosure more clearly, the disclosure is further described in detail in combination with drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by protection of the disclosure.

Terms “first”, “second”, “third”, “fourth”, if any, in specification, claims and drawings of this application are used to distinguish similar objects and need not be used to describe any particular order or sequence of priorities. It should be understood that data are interchangeable when appropriate, in other words, the embodiments described can be implemented in order other than what is illustrated or described here. In addition, terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that description refers to “first”, “second”, etc. in the disclosure are for descriptive purpose only and neither be construed or implied relative importance nor indicated as implying number of technical features. Thus, feature defined as “first” or “second” can explicitly or implicitly include one or more features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

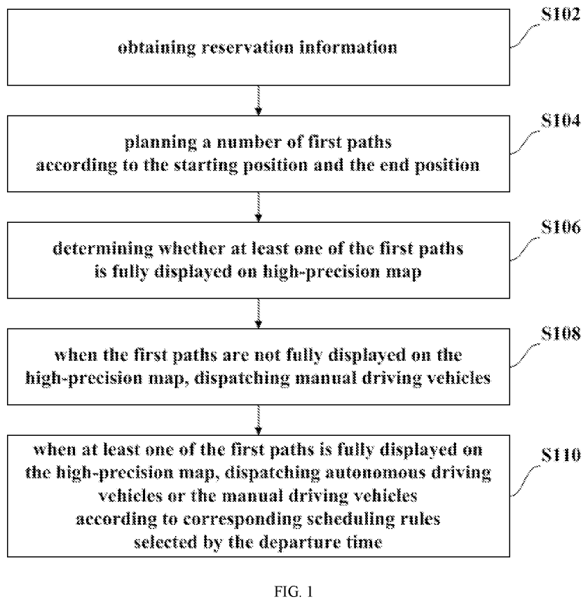

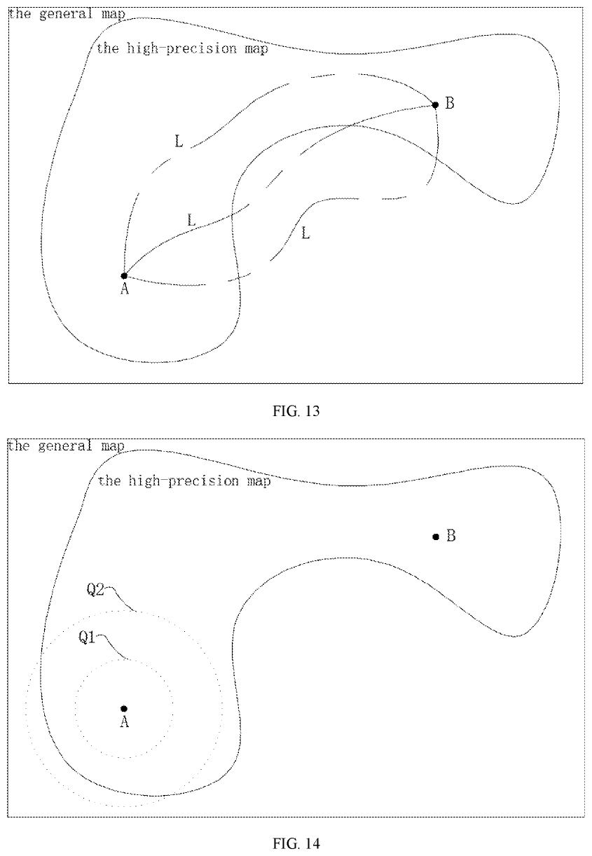

Referring to FIG. 1 and FIG. 13, FIG. 1 illustrates a flow diagram of a vehicle scheduling method in accordance with a first embodiment, FIG. 13 illustrates a first schematic diagram of a vehicle scheduling method in accordance with the first embodiment. The vehicle scheduling method is used for dispatching transport equipment, so as to realize carrying of passengers, loads, etc. The transport equipment includes but is not limited to cars, motorcycles, trucks, sport utility vehicles, recreational vehicles, aircrafts and so on. In this embodiment, the vehicle scheduling method applied to dispatch manual driving vehicles 10 and autonomous driving vehicles 20. The manual driving vehicles 10 are vehicles driven by human drivers. The autonomous driving vehicles 20 have a level-five autonomous driving system. The level-five autonomous driving system refers to “full automation”. A vehicle with the level-five autonomous driving system can drive automatically in any legal and drivable road environment. The human driver only needs to set destination and turn on the level-five autonomous driving system, and the vehicle can drive to the designated place through an optimized route. The vehicle scheduling method comprises the following steps.

In step S102, reservation information is obtained. This disclosure uses a main control device 31 to obtain the reservation information. In this embodiment, the reservation information comes from clients connected in communication with the main control device 31 (not shown). Customers can input the reservation information to book vehicles through the clients, so as to realize reservation of travel. Clients include but are not limited to mobile phones, computers, tablets, electronic watches and other electronic devices. The reservation information includes a starting position A, an end position B, and a departure time.

In step S104, a number of first paths are planned according to the starting position and the end position. This disclosure uses the main control device 31 to plan a number of first paths L from the starting position A to the end position B according to the starting position A and the end position B. In this embodiment, the main control device 31 plans the first paths L on a general map. The general map is a map suitable for the manual driving vehicles 10.

In step S106, it is determined that whether at least one of the first paths is fully displayed on high-precision map. This disclosure uses the main control device 31 to determine whether at least one of the first paths L is fully displayed on the high-precision map. The high-precision map is a map suitable for the autonomous driving vehicles 20.

In step S108, when the first paths are not fully displayed on the high-precision map, the manual driving vehicles are dispatched. It is understandable that the manual driving vehicles 10 can drive according to all paths planned on the general map, the autonomous driving vehicles 20 can only drive according to paths displayed on the high-precision map. Therefore, when there is no first path L fully displayed on the high-precision map, the main control device 31 dispatches the manual driving vehicles 10. In this embodiment, method of dispatching the manual driving vehicles 10 by the main control device 31 is basically consistent with method of dispatching order dispatching by online car-hailing platform.

In step S110, when at least one of the first paths is fully displayed on the high-precision map, the autonomous driving vehicles or the manual driving vehicles are dispatching according to corresponding scheduling rules selected by the departure time. It is understandable that when at least one first path L is fully displayed on the high-precision map, vehicles can be dispatched include the manual driving vehicle 10 and the autonomous driving vehicles 20. The scheduling rules include a first scheduling rule and a second scheduling rule. The main control device 31 obtains time of current moment, and calculates time difference between the time of current moment and the departure time. The main control device 31 determines whether the time difference is less than or equal to first preset time. When the time difference is less than or equal to the first preset time, the first scheduling rule is selected to dispatch the autonomous driving vehicles 20 or the manual driving vehicles 10. When the time difference is greater than the first preset time, the second scheduling rule is selected to dispatch the autonomous driving vehicles 20 or the manual driving vehicles 10. In this embodiment, the first preset time is one hour. When the time difference is less than or equal to the first preset time, it can be considered that the customers need to start immediately. When the time difference is greater than the first preset time, it can be considered that the customers only arrange itinerary in advance through the clients, not immediately. It is understandable that this disclosure performs dispatching according to the first scheduling rule and the second scheduling rule based on the departure time. Specific scheduling method will be described in detail below.

In some embodiments, the main control device 31 can determine whether the departure time is in the rush hour according to prior knowledge or whether the first path L is currently in a congested state according to prior knowledge. When the departure time is in the rush hour or the first path L is currently in a congested state, the main control device 31 can send prompt messages to the clients to ask the customers whether to change the starting position A or the departure time.

In the above embodiment, a number of first paths are planned according to the starting position and the end position of the reservation information, and select the corresponding scheduling rules to dispatch the manual driving vehicles or the autonomous driving vehicles by determining whether at least one of the first paths is fully displayed on the high-precision map and the departure time. Since the autonomous driving vehicles need to depend on the high-precision map, only manual driving vehicles can be dispatched when there is no first path that can be fully displayed on the high-precision map. It can be determined whether the customers need to leave immediately or arrange the itinerary in advance according to the time difference between the departure time and the time of current moment.

Corresponding scheduling rules are selected to dispatch the manual driving vehicles or the autonomous driving vehicles according to these different situations, which makes the scheduling of vehicles more reasonable. At the same time, dispatching vehicles according to different scheduling rules can also dispatch vehicles most efficiently and improve the utilization rate of vehicles.

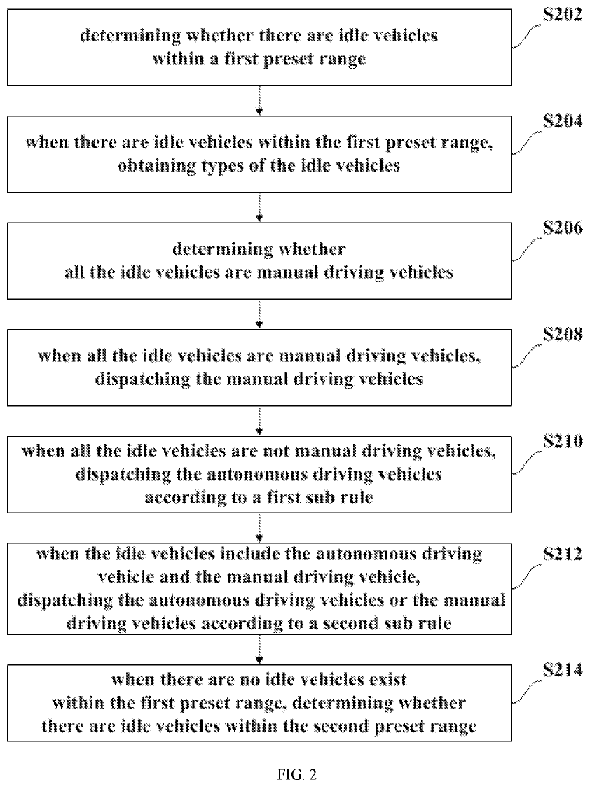

Referring to FIG. 2 and FIG. 14, FIG. 2 illustrates a first sub flow diagram of a vehicle scheduling method in accordance with the first embodiment, FIG. 14 illustrates a second schematic diagram of a vehicle scheduling method in accordance with the first embodiment. In step S110, the first scheduling rule is selected to dispatch the autonomous driving vehicles or the manual driving vehicles includes the following steps.

In step S202, it is determined whether there are idle vehicles within a first preset range. The main control device 31 determines whether there are idle vehicles within the first preset range Q1. In this embodiment, the first preset range Q1 is an area covered by a circle with the starting position A as a center and a first preset length as a radius. The first preset length is product of first predetermined time and a predetermined speed. Preferably, the first predetermined time is 10 minutes and the predetermined speed is 40 km/h. The first preset length is 6.67 km. It is understandable that when speed of the vehicles is 40 km/h, range in which the vehicles can reach the starting position A in about 10 minutes is the first preset range Q1. In some embodiment, the first preset range Q1 may be an area covered by a square with the starting position A as a center and the first preset length as a side length. In other embodiment, the first predetermined time and the predetermined speed can be set according to actual situation.

In step S204, when there are idle vehicles within the first preset range, types of the idle vehicles are obtained. The types of the idle vehicles include autonomous driving vehicle and manual driving vehicle.

In some embodiment, the main control device 31 can calculate number of the idle vehicles. When it is determined that the number of the idle vehicles is small, the main control device 31 can send the prompt messages to the clients to ask the customers whether to change the starting position A or the departure time.

In step S206, it is determined whether all the idle vehicles are manual driving vehicles. This disclosure uses the main control device 31 to determine whether all the idle vehicles are manual driving vehicles 10.

In step S208, when all the idle vehicles are manual driving vehicles, the manual driving vehicles 10 are dispatching. In this embodiment, when all the idle vehicles are manual driving vehicles 10, the main control device 31 dispatches the manual driving vehicles 10. The method of dispatching the manual driving vehicles 10 by the main control device 31 is basically consistent with method of dispatching order dispatching by online car-hailing platform.

In step S210, when all the idle vehicles are not manual driving vehicles, the autonomous driving vehicles are dispatched according to a first sub rule. It is understandable that when all the idle vehicles are not manual driving vehicles 10, only the autonomous driving vehicles 20 can be dispatched. Specific process of dispatching the autonomous driving vehicles 20 according to the first sub rule will be described in detail below.

In step S212, when the idle vehicles include the autonomous driving vehicles and the manual driving vehicles, the autonomous driving vehicles 20 or the manual driving vehicles 10 are dispatching according to a second sub rule. Specific process of dispatching the autonomous driving vehicles 20 or the manual driving vehicles 10 according to the first sub rule will be described in detail below.

In step S214, when there are no idle vehicles exist within the first preset range, it is determined whether there are idle vehicles within the second range. The second preset range Q2 is larger than the first preset range Q1. It is understandable that when there are no idle vehicles exist within the first preset range Q1, the main control device 31 expands range to find the idle vehicles. In this embodiment, the second preset range Q2 is an area covered by a circle with the starting position A as a center and a second preset length as a radius. The second preset length is product of second predetermined time and the predetermined speed. The second preset length is larger than the first preset length. Preferably, the second predetermined time is 20 minutes and the predetermined speed is 40 km/h. The second preset length is 13.33 km. It is understandable that when speed of the vehicles is 40 km/h, range in which the vehicles can reach the starting position A in about 20 minutes is the second preset range Q2. In some embodiment, the second preset range Q2 may be an area covered by a square with the starting position A as a center and the second preset length as a side length. In other embodiment, the second predetermined time and the predetermined speed can be set according to actual situation.

In the above embodiment, when it is determined that the customers need to start immediately according to the time difference between the departure time and the time of current moment, whether there are idle vehicles within the first preset range is obtained. Then, according to the type of idle vehicles within the first preset range, different sub rules are selected to dispatch the manual driving vehicles or the autonomous driving vehicles. When there are no idle vehicles within the first preset range, the idle vehicles can be obtained by expanding to the second preset range. This disclosure can quickly dispatch idle vehicles and improve the utilization rate of vehicles at the same time.

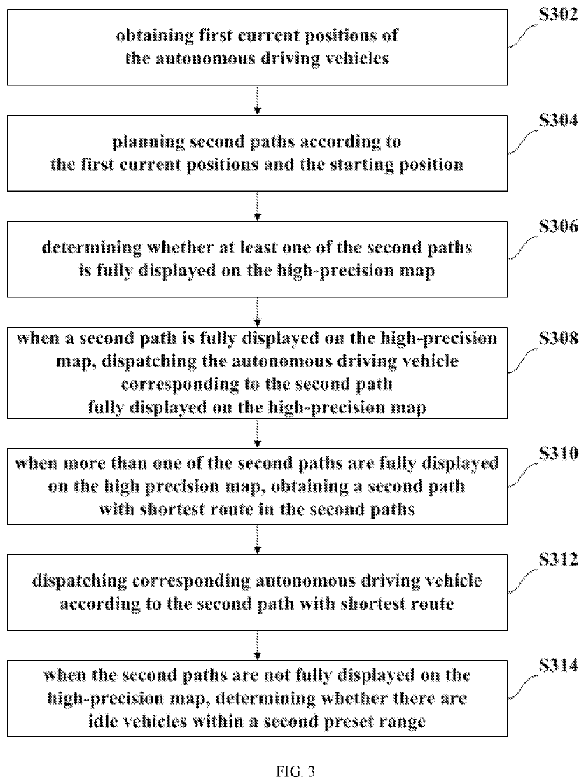

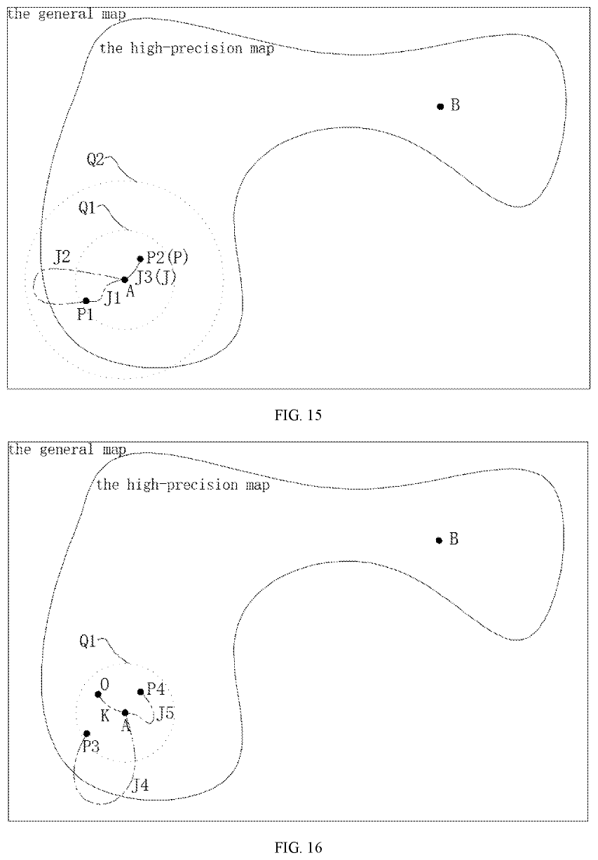

Referring to FIG. 3 and FIG. 15, FIG. 3 illustrates a second sub flow diagram of a vehicle scheduling method in accordance with the first embodiment, FIG. 15 illustrates a third schematic diagram of a vehicle scheduling method in accordance with the first embodiment. Step S210 includes the following steps.

In step S302, first current positions of the autonomous driving vehicles are obtained. This disclosure uses the main control device 31 to obtain the first current positions P of the autonomous driving vehicles 20. It is understandable that the autonomous driving vehicles 20 are located within the first preset range Q1 and are idle vehicles. The main control device 31 obtains the first current positions P of the autonomous driving vehicles 20 on the general map. For example, idle autonomous driving vehicles 20 within the first preset range Q1 are two, and the first current positions of two autonomous driving vehicles 20 are P1 and P2.

In step S304, second paths are planned according to the first current position and the starting position. This disclosure uses the main control device 31 to plan the second paths J from the first current positions P to the starting position A according to the first current position P and the starting position A. In this embodiment, the main control device 31 plans the second paths J on the general map. For example, there are two second paths of the autonomous driving vehicle 20 at the first current position P1, respectively, J1 and J2. The second path of the autonomous driving vehicle 20 at the first current position P2 is J3. It is understandable that each autonomous driving vehicle 20 can be planned a second path J or multiple second paths J, which can be planned according to the actual situation.

In step S306, it is determined whether at least one of the second paths is fully displayed on the high-precision map. This disclosure uses the main control device 31 to determine whether at least one of the second paths J is fully displayed on the high-precision map. For example, the second path J2 of the autonomous driving vehicle 20 at the first current position P1 is not fully displayed on the high-precision map. The second path J1 of the autonomous driving vehicle 20 at the first current position P1 and the second path J3 of the autonomous driving vehicle 20 at the first current position P2 are fully displayed on the high-precision map.

In step S308, when a second path is fully displayed on the high-precision map, the autonomous driving vehicle corresponding to the second path fully displayed on the high-precision map is dispatched. It is understandable that when only one second path J is fully displayed on the high-precision map, only the autonomous driving vehicle 20 corresponding to the second path J can be dispatched. In this embodiment, the main control device 31 dispatches the corresponding autonomous driving vehicle 20 to drive to the starting position A according to the second path J.

In step S310, when more than one of the second paths are fully displayed on the high-precision map, a second path with shortest route in the second paths is obtained. It is understandable that when more than one of the second paths J are fully displayed on the high-precision map, there are at least two autonomous driving vehicles 20 that can be dispatched, or only one autonomous driving vehicle 20 that can be dispatched. The only one autonomous driving vehicle 20 has multiple second paths J that can travel to the starting position A. This disclosure uses the main control device 31 to obtain the second path with shortest route in the second paths J. For example, among the second path J1 and the second path J3 fully displayed on the high-precision map, the shortest route is the second path J3. Then, the main control device 31 obtains the second path J3.

In step S312, corresponding autonomous driving vehicle is dispatched according to the second path with shortest route. This disclosure uses the main control device 31 to dispatch corresponding autonomous driving vehicle 20 according to the second path J with shortest route. For example, the shortest route is the second path J3, the main control device 31 dispatches the autonomous driving vehicle 20 at the first current position P2. In this embodiment, the main control device 31 dispatches the autonomous driving vehicle 20 to drive to the starting position A according to the second path J3.

In step S314, when the second paths are not fully displayed on the high-precision map, it is determined whether there are idle vehicles within the second preset range. The second preset range Q2 is larger than the first preset range Q1. It is understandable that when the second paths J are not fully displayed on the high-precision map, it indicates that there are no autonomous driving vehicles 20 that can be dispatched within the first preset range Q1. Then the main control device 31 expands range to re-find the idle vehicles. In this embodiment, the second preset range Q2 is an area covered by a circle with the starting position A as a center and a second preset length as a radius. The second preset length is product of second predetermined time and the predetermined speed. The second preset length is larger than the first preset length. Preferably, the second predetermined time is 20 minutes and the predetermined speed is 40 km/h. The second preset length is 13.33 km. It is understandable that when speed of the vehicles is 40 km/h, range in which the vehicles can reach the starting position A in about 20 minutes is the second preset range Q2. In some embodiment, the second preset range Q2 may be an area covered by a square with the starting position A as a center and the second preset length as a side length. In other embodiment, the second predetermined time and the predetermined speed can be set according to actual situation.

In the above embodiment, when the idle vehicles are autonomous driving vehicles, the second paths are planned according to the first current position and the starting position, and it is determined whether the second paths are fully displayed on the high-precision map. When only one second path is fully displayed on the high-precision map, the corresponding autonomous driving vehicle is dispatched. When a plurality of second paths is fully displayed on the high-precision map, the autonomous driving vehicle corresponding to the second path with shortest route is dispatched. It enables the autonomous driving vehicle to reach the starting position to connect with the customers in the shortest time, which greatly improves the customers' riding experience. When no second path is fully displayed on the high-precision map, it is expanded to the second preset range to obtain the idle vehicles.

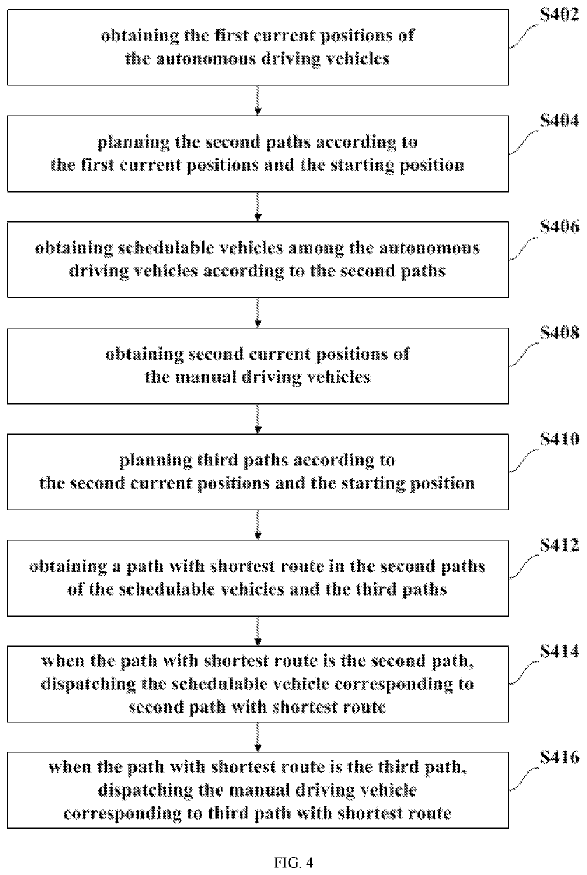

Referring to FIG. 4 and FIG. 16, FIG. 4 illustrates a third sub flow diagram of a vehicle scheduling method in accordance with the first embodiment, FIG. 16 illustrates a fourth schematic diagram of a vehicle scheduling method in accordance with the first embodiment. Step S212 includes the following steps.

In step S402, the first current positions of the autonomous driving vehicles are obtained. This disclosure uses the main control device 31 to obtain the first current positions P of the autonomous driving vehicles 20. It is understandable that the autonomous driving vehicles 20 are within the first preset range Q1 and are idle vehicles. The main control device 31 obtains the first current positions P of the autonomous driving vehicles 20 on the general map. For example, idle autonomous driving vehicles 20 within the first preset range Q1 are two, and the first current positions of two autonomous driving vehicles 20 are P3 and P4.

In step S404, the second paths are planned according to the first current positions and the starting position. This disclosure uses the main control device 31 to plan second paths J from the first current positions P to the starting position A according to the first current positions P and the starting position A. In this embodiment, the main control device 31 plans the second paths J on the general map. For example, the second path of the autonomous driving vehicle 20 at the first current position P1 is J4, the second path of the autonomous driving vehicle 20 at the first current position P2 is J5. It is understandable that each autonomous driving vehicle 20 can plan a second path J or multiple second paths J, which can be planned according to the actual situation.

In step S406, schedulable vehicles are obtained among the autonomous driving vehicles according to the second paths. This disclosure uses the main control device 31 to determine whether the second paths J are fully displayed on the high-precision map. When the second paths J are fully displayed on the high-precision map, the autonomous driving vehicles 20 corresponding to the second paths J are selected as the schedulable vehicles. For example, the second path J4 of the autonomous driving vehicle 20 at the first current position P3 is not fully displayed on the high-precision map. The second path J5 of the autonomous driving vehicle 20 at the first current position P4 is fully displayed on the high-precision map. Then the main control device 31 selects the autonomous driving vehicle 20 at the first current position P4 as the schedulable vehicle.

In step S408, second current positions of the manual driving vehicles are obtained. This disclosure uses the main control device 31 to obtain the second current positions O of the manual driving vehicles 10. It is understandable that the manual driving vehicles 10 are within the first preset range Q1 and are idle vehicles. The main control device 31 obtains the second current position O of the manual driving vehicles 10 on the general map. For example, idle manual driving vehicle 10 within the first preset range Q1 is one, and the second current position of the manual driving vehicle 10 is O.

In step S410, third paths are planned according to the second current positions and the starting position. This disclosure uses the main control device 31 to plan the third paths K from the second current positions O to the starting position A according to the second current positions O and the starting position A. In this embodiment, the main control device 31 plans the third paths K on the general map. For example, the third path of the manual driving vehicle 10 at the second current position O is K. It is understandable that each manual driving vehicle 10 can plan a third path K or multiple third paths K, specifically planning according to the actual situation.

In step S412, a path with shortest route in the second paths of the schedulable vehicles and the third paths is obtained. This disclosure uses the main control device 31 to obtain a path with shortest route in the second paths J of the schedulable vehicles and the third paths K. For example, among the second path J5 of the schedulable vehicle and the third path K, the shortest route is the third path K. Then the main control device 31 obtains the third path K.

In step S414, when the path with shortest route is the second path, the schedulable vehicle corresponding to second path with shortest route is dispatched. This disclosure uses the main control device 31 to dispatch corresponding schedulable vehicle according to the second path J with shortest route, and control the schedulable vehicle to drive to the starting position A according to the second path J.

In step S416, when the path with shortest route is the third path, the manual driving vehicle corresponding to third path with shortest route is dispatched. This disclosure uses the main control device 31 to dispatch corresponding manual driving vehicle 10 according to the third path K with shortest route. The method of dispatching manual driving vehicle 10 by the main control device 31 is basically consistent with the dispatching method of the online ride-hailing platform. For example, the main control device 31 sends the order to the manual driving vehicle 10 at the second current position O.

In the above embodiment, when the idle vehicles include the manual driving vehicles and the autonomous driving vehicles, the second paths are planned according to the first current positions of the autonomous driving vehicles and the starting position, and the schedulable vehicles are selected according to whether the second paths are fully displayed on the high-precision map. The third paths are planned according to the second current positions of the manual driving vehicles and the starting position, and the path with shortest route is selected from the second paths fully displayed on the high-precision map and the third paths. Then the corresponding vehicle is dispatched. Thus, the vehicle can be dispatched to the starting position to connect with the customers in the shortest time, which greatly improves the customers' riding experience.

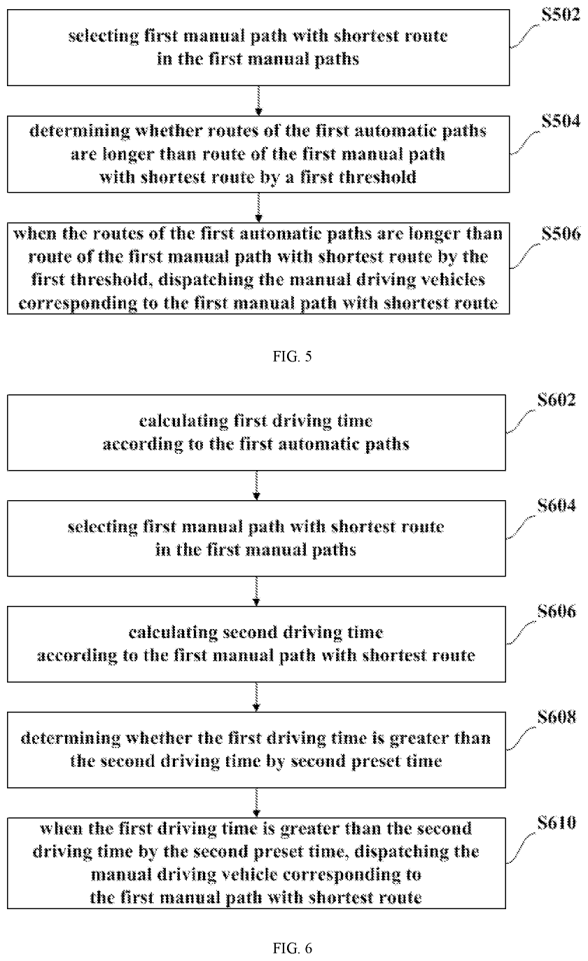

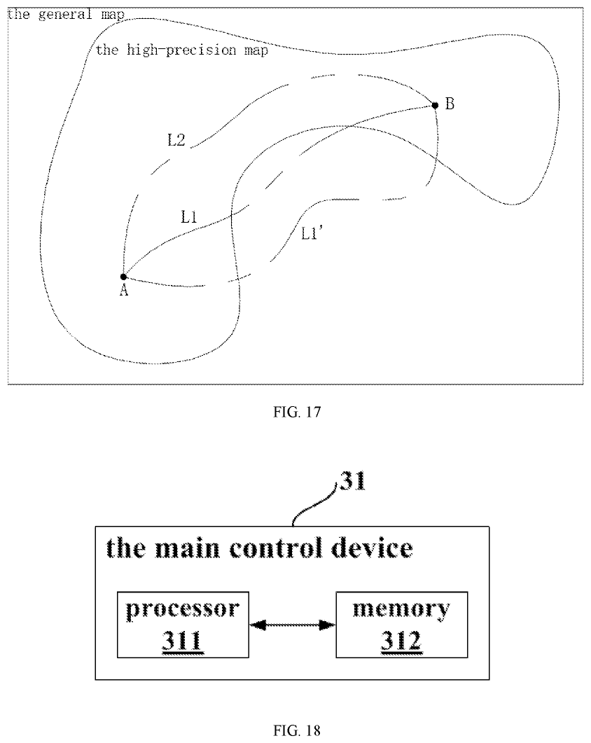

Referring to FIG. 5 and FIG. 17, FIG. 5 illustrates a sub flow diagram of a vehicle scheduling method in accordance with a second embodiment, FIG. 17 illustrates a schematic diagram of a vehicle scheduling method in accordance with the second embodiment. In this embodiment, the first paths L include first automatic paths L2 suitable for the autonomous driving vehicles 20 and first manual paths L1 suitable for the manual driving vehicles 10. The first automatic paths L2 are paths that can be fully displayed on the high-precision map, and the first manual paths L1 are paths displayed on the general map. The difference between the vehicle scheduling method provided by the second embodiment and the vehicle scheduling method provided by the first embodiment is that when the schedulable vehicles are the autonomous driving vehicles 20, step S212 also includes the following steps.

In step S502, first manual path with shortest route in the first manual paths is selected. This disclosure uses the main control device 31 to select the first manual path L1 with shortest route among the first manual paths L1 planned. For example, the main control device 31 plans two first manual paths L1 and L1′. The route of the first manual path L1 is the shortest.

In step S504, it is determined whether routes of the first automatic paths are longer than route of the first manual path with shortest route by a first threshold. This disclosure uses the main control device 31 to determine whether routes of the first automatic paths L2 are longer than route of the first manual path L1 with shortest route by the first threshold. Preferably, the first threshold is 5 km. It is understandable that the first automatic paths L2 are paths from the starting position A to the end position B of the autonomous driving vehicles 20 selected and been prepared to dispatch according to the second scheduling sub rule by the main control device 31.

In step S506, when the routes of the first automatic paths are longer than route of the first manual path with shortest route by the first threshold, the manual driving vehicles corresponding to the first manual path with shortest route is dispatched. It is understandable that when the routes of the first automatic paths L2 are longer than route of the first manual path L1 with shortest distance, and route difference is greater than or equal to 5 km, the main control device 31 dispatches the manual driving vehicle 10 corresponding to the first manual path L1 with shortest route. That is, although it can be determined that the autonomous driving vehicle 20 has the shortest route drive to the starting position A according to the second sub rule, however, route for the autonomous driving vehicle 20 to drive from the starting position A to the end position B is much longer than route for the manual driving vehicle 10 to drive from the starting position A to the end position B. So, the main control device 31 dispatches the manual driving vehicle 10.

In the above embodiment, when the second paths of the schedulable vehicles are short and the schedulable vehicles are the autonomous driving vehicles, it is necessary to determine whether the routes of the first automatic paths are shorter or the routes of the first manual paths are shorter. When the routes of the first automatic paths are longer than the routes of the first manual paths and exceeds the first threshold, it indicates that the route for the autonomous driving vehicle to drive from the starting position to the end position is much longer than that of the manual driving vehicle. Due to price will be calculated according to the route from the starting position to the end position, if the route is much longer, it will incur unnecessary expenses. Therefore, from the customers' point of view, it is better to dispatch the manual driving vehicles in this case, so as to enhance the customers' riding experience.

Referring to FIG. 6, FIG. 6 illustrates a sub flow diagram of a vehicle scheduling method in accordance with a third embodiment. The difference between the vehicle scheduling method provided by the third embodiment and the vehicle scheduling method provided by the first embodiment is that when the schedulable vehicles are the autonomous driving vehicles, step S212 also includes the following steps.

In step S602, first driving time according to the first automatic paths are calculated. This disclosure uses the main control device 31 to calculate the first driving time required by the autonomous driving vehicles 20 to drive at an automatic predetermined speed according to the first automatic paths L2. It is understandable that the first automatic paths L2 are paths from the starting position A to the end position B of the autonomous driving vehicles 20 selected and been prepared to dispatch according to the second scheduling sub rule by the main control device 31. The automatic predetermined speed is 30 km/h.

In step S604, first manual path with shortest route in the first manual paths is selected. This disclosure uses the main control device 31 to select the first manual path with shortest route among the planned first manual paths L1.

In step S606, second driving time according to the first manual path with shortest route is calculated. This disclosure uses the main control device 31 to calculate the second driving time required by the manual driving vehicles 10 to drive at a manual predetermined speed according to the first manual path L1 with shortest route. The manual predetermined speed is 40 km/h.

In step S608, it is determined whether the first driving time is greater than the second driving time by second preset time. This disclosure uses the main control device 31 to determine whether the first driving time is greater than the second driving time by second preset time. Preferably, the second preset time is 30 minutes. In some embodiments, the second preset time may be any value between 20 and 30 minutes.

In step S610, when the first driving time is greater than the second driving time by the second preset time, the manual driving vehicle corresponding to the first manual path with shortest route is dispatched. It is understandable that when the first driving time required by the autonomous driving vehicles 20 to drive from the starting position A to the end position B is longer than the second driving time required by the manual driving vehicle 10 to drive from the starting position A to the end position B according to the shortest route, and the time difference is more than 30 minutes, the main control device 31 dispatches the manual driving vehicle 10 corresponding to the first manual path L1 with shortest route. That is, although it can be determined that the autonomous driving vehicle 20 has the shortest route drive to the starting position A according to the second sub rule, however, time for the autonomous driving vehicle 20 to drive from the starting position A to the end position B is much longer than time for the manual driving vehicle 10 to drive from the starting position A to the end position B. So, the main control device 31 dispatches the manual driving vehicle 10.

In the above embodiment, when the second paths of the schedulable vehicles are short and the schedulable vehicles are the autonomous driving vehicles, it is necessary to determine whether the first driving time is shorter or the second driving time is shorter. When the first driving time is longer than the second driving time and exceeds the second preset time, it indicates that the time for the autonomous driving vehicle to drive from the starting position to the end position is much longer than that of the manual driving vehicle. From the customers' point of view, in order to avoid customers wasting too much time on the way, it is better to dispatch manual driving vehicle in this case, so as to improve the customers' riding experience.

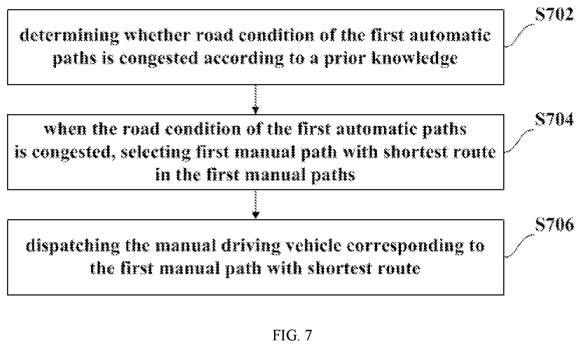

Referring to FIG. 7, FIG. 7 illustrates a sub flow diagram of a vehicle scheduling method in accordance with a fourth embodiment. The difference between the vehicle scheduling method provided by the fourth embodiment and the vehicle scheduling method provided by the first embodiment is that when the schedulable vehicles are the autonomous driving vehicles, step S212 also includes the following steps.

In step S702, it is determined whether road condition of the first automatic paths is congested according to a prior knowledge. This disclosure uses the main control device 31 to determine according to the prior knowledge. It is understandable that the first automatic paths L2 are paths from the starting position A to the end position B of the autonomous driving vehicles 20 selected and been prepared to dispatch according to the second scheduling sub rule by the main control device 31.

In step S704, when the road condition of the first automatic paths is congested, first manual path with shortest route in the first manual paths is selected. When the road condition of the first automatic paths L2 is congested, this disclosure uses the main control device 31 to select the first manual path with shortest route among the planned first manual paths L1.

In step S706, the manual driving vehicle corresponding to the first manual path with shortest route is dispatched. This disclosure uses the main control device 31 to dispatch the manual driving vehicle 10 corresponding to the first manual path L1 with shortest route.

In some embodiments, the main control device 31 may also determine whether the departure time is during the rush hour according to the prior knowledge. When the departure time is during the rush hour, the manual driving vehicle 10 corresponding to the first manual path L1 with the shortest route is dispatched.

In the above embodiment, when the second paths of the schedulable vehicles are short and the schedulable vehicles are the autonomous driving vehicles, it is necessary to determine according to the prior knowledge, that is, to determine whether the road condition of the first automatic paths is congested or whether the departure time is during the rush hour. As human drivers can better cope with complex and congested road conditions, it is better to dispatch manual driving vehicles when the road conditions are congested or when the departure time is during the rush hour, so as to enhance the customers' riding experience.

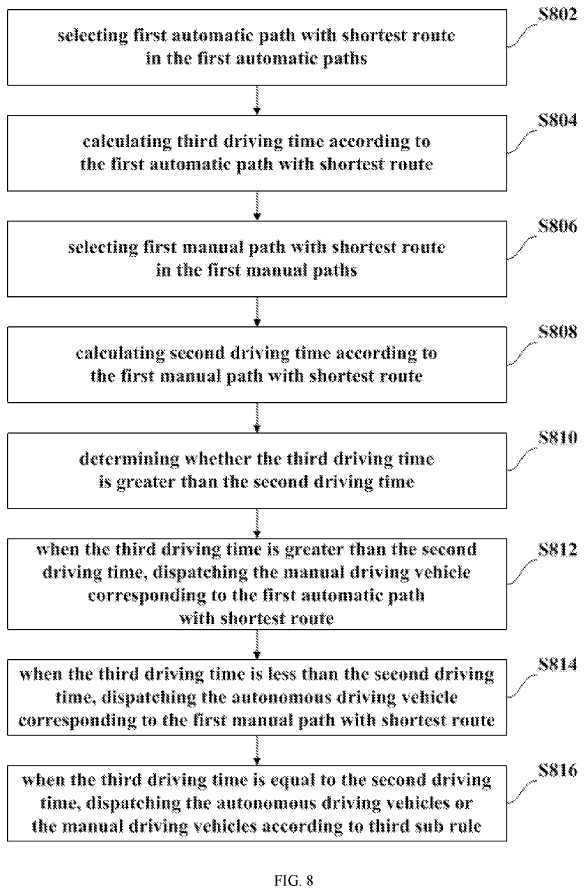

Referring to FIG. 8, FIG. 8 illustrates a fourth sub flow diagram of a vehicle scheduling method in accordance with the first embodiment. In this embodiment, the first paths L include first automatic paths L2 suitable for the autonomous driving vehicles 20 and first manual paths L1 suitable for the manual driving vehicles 10. The first automatic paths L2 are paths that can be fully displayed on the high-precision map, and the first manual paths L1 are paths displayed on the general map. In step S110, the second scheduling rule is selected to dispatch the autonomous driving vehicles 20 or the manual driving vehicles 10 includes the following steps.

In step S802, first automatic path with shortest route in the first automatic paths is selected. This disclosure uses the main control device 31 to select the first automatic path with shortest route among the planned first automatic paths L2.

In step S804, third driving time according to the first automatic path with shortest route is calculated. This disclosure uses the main control device 31 to calculate the third driving time required by the autonomous driving vehicles 20 to drive at the automatic predetermined speed according to the first automatic path L2 with shortest route. The automatic predetermined speed is 30 km/h.

In step S806, first manual path with shortest route in the first manual paths is selected. This disclosure uses the main control device 31 to select the first manual path with shortest route among the planned first manual paths L1.

In step S808, second driving time according to the first manual path with shortest route is calculated. This disclosure uses the main control device 31 to calculate the second driving time required by the manual driving vehicles 10 to drive at a manual predetermined speed according to the first manual path L1 with shortest route. The manual predetermined speed is 40 km/h.

In step S810, it is determined whether the third driving time is greater than the second driving time.

In step S812, when the third driving time is greater than the second driving time, the manual driving vehicle corresponding to the first automatic path with shortest route is dispatched. Specific scheduling process will be described in detail below.

In step S814, when the third driving time is less than the second driving time, the autonomous driving vehicle corresponding to the first manual path with shortest route is dispatched. Specific scheduling process will be described in detail below.

In step S816, when the third driving time is equal to the second driving time, the autonomous driving vehicles or the manual driving vehicles according to third sub rule are dispatched. Specific scheduling process will be described in detail below.

In the above embodiment, when it is determined that the time difference between the time of current moment and the departure time is greater than the first preset time, that is, the customers arranges trips in advance through the clients, dispatching is carried out according to the third driving time required by the autonomous driving vehicles and the second driving time required by the manual driving vehicles from the starting position to the end position, which greatly improves the customers' riding experience.

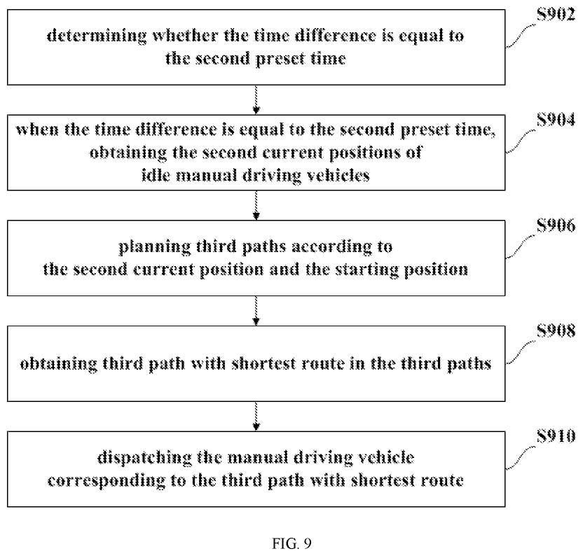

Referring to FIG. 9, FIG. 9 illustrates a fifth sub flow diagram of a vehicle scheduling method in accordance with the first embodiment. Step S812 includes the following steps.

In step S902, it is determined whether the time difference is equal to the second preset time. The second preset time is less than the first preset time. Preferably, the second preset time is 30 minutes.

In step S904, when the time difference is equal to the second preset time, the second current positions of idle manual driving vehicles are obtained. This disclosure uses the main control device 31 to obtain the second current positions O of the idle manual driving vehicles 10. The main control device 31 can obtain the idle manual driving vehicles 10 within a preset range, or all idle manual driving vehicles 10.

In step S906, third paths are planned according to the second current position and the starting position. This disclosure uses the main control device 31 to plan the third paths K from the second current positions O to the starting position A according to the second current positions O and the starting position A. In this embodiment, the main control device 31 plans the third paths K on the general map. Each manual driving vehicles 10 can plan a third path K, or a number of third paths K, which can be planned according to the actual situation.

In step S908, third path with shortest route in the third paths is obtained.

In step S910, the manual driving vehicle corresponding to the third path with shortest route is dispatched. This disclosure uses the main control device 31 to dispatch the manual driving vehicle 10 corresponding to the third path K with shortest route. In this embodiment, the main control device 31 stops the manual driving vehicle 10 at the second current position O and calculates fourth driving time according to the third path K with shortest route. The fourth driving time is time required for the manual driving vehicle 10 to drive from the second current position O to the starting position A according to the third path K at the manual predetermined speed. The main control device 31 dispatches the manual driving vehicle 10 according to the fourth driving time, the time of current moment, and the departure time. Preferably, the main control device 31 calculates whether time difference between the time of current moment and the departure time is equal to the fourth driving time. When the time difference between the time of current moment and the departure time is equal to the fourth driving time, the main control device 31 informs the manual driving vehicle 10 to drive to the starting position A according to the third path K. In some embodiments, the main control device 31 may notify the manual driving vehicle 10 to drive to the starting position A when the time difference between the time of current moment and the departure time is greater than the fourth driving time. How much the time difference between the time of current moment and the departure time is larger than the fourth driving time can be set according to the actual situation.

In the above embodiment, when the manual driving vehicles are dispatched, the main control device first stops the manual driving vehicle with the shortest route to the starting position at the second current position when it is ahead of the departure time by the second preset time. Then the main control device will inform the manual driving vehicle to drive to the starting position at an appropriate time, so that the manual driving vehicle can connect with the customer in advance or just reach the starting position at the departure time, so as to dispatch the vehicles most efficiently and the utilization rate of the vehicles can be improved.

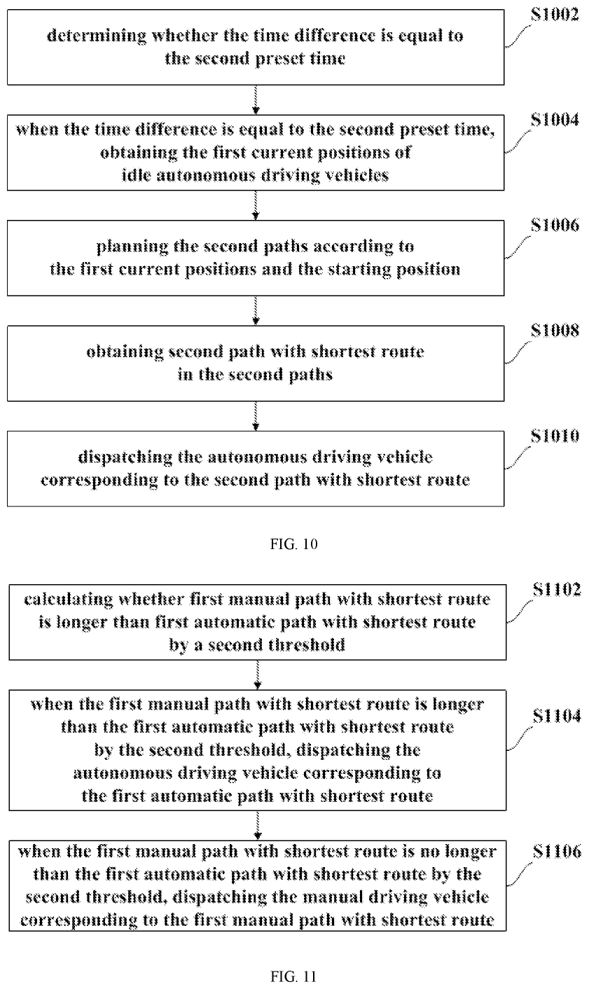

Referring to FIG. 10, FIG. 10 illustrates a sixth sub flow diagram of a vehicle scheduling method in accordance with the first embodiment. Step S814 includes the following steps.

In step S1002, it is determined whether the time difference is equal to the second preset time. The second preset time is less than the first preset time. Preferably, the second preset time is 30 minutes.

In step S1004, when the time difference is equal to the second preset time, the first current positions of idle autonomous driving vehicles are obtained. This disclosure uses the main control device 31 to obtain the first current positions P of the idle autonomous driving vehicles 20. The main control device 31 can obtain the idle autonomous driving vehicles 20 within the preset range, or all idle autonomous driving vehicles 10.

In step S1006, the second paths are planned according to the first current positions and the starting position. This disclosure uses the main control device 31 to plan the second paths J from the first current positions P to the starting position A according to the first current positions P and the starting position A. In this embodiment, the main control device 31 plans the second paths J on the high-precision map. Each autonomous driving vehicle 20 can plan a second path J, or a number of second paths J, the second path can be planned according to the actual situation.

In step S1008, second path with shortest route in the second paths is obtained.

In step S1010, the autonomous driving vehicle corresponding to the second path with shortest route is dispatched. This disclosure uses the main control device 31 to dispatch the autonomous driving vehicle 20 corresponding to the second path J with shortest route. In this embodiment, the main control device 31 controls the autonomous driving vehicle 10 to stop at the first current position P and calculates fifth driving time according to the second path J with shortest route. The fifth driving time is time required for the autonomous driving vehicle 20 to drive from the first current position P to the starting position A according to the second path J at the autonomous predetermined speed. The main control device 31 dispatches the autonomous driving vehicle 20 according to the fifth driving time, the time of current moment, and the departure time. Preferably, the main control device 31 calculates whether time difference between the time of current moment and the departure time is equal to the fifth driving time. When the time difference between the time of current moment and the departure time is equal to the fifth driving time, the main control device 31 sends an instruction to the autonomous driving vehicle 20 to drive to the starting position A according to the second path J. In some embodiments, the main control device 31 may control the autonomous driving vehicle 20 to drive to the starting position A when the time difference between the time of current moment and the departure time is greater than the fifth driving time. How much the time difference between the time of current moment and the departure time is larger than the fifth driving time can be set according to the actual situation.

In the above embodiment, when the autonomous driving vehicles are dispatched, the main control device first stops the autonomous driving vehicle with the shortest route to the starting position at the first current position when it is ahead of the departure time by the second preset time. Then the main control device will send the instruction to the autonomous driving vehicle at an appropriate time, so that the autonomous driving vehicle can connect with the customer in advance or just reach the starting position at the departure time, so as to dispatch the vehicles most efficiently and the utilization rate of the vehicles can be improved.

Referring to FIG. 11, FIG. 11 illustrates a seventh sub flow diagram of a vehicle scheduling method in accordance with the first embodiment. Step S816 includes the following steps.

In step S1102, whether first manual path with shortest route is longer than first automatic path with shortest route by a second threshold is calculated. Preferably, the second threshold is 3 km.

In step S1104, when the first manual path with shortest route is longer than the first automatic path with shortest route by the second threshold, the autonomous driving vehicle corresponding to the first automatic path with shortest route is dispatched. It is understandable that when the first manual path L1 with shortest route is longer than the first automatic path L2 with shortest route, and route difference is greater than or equal to 3 km, the main control device 31 dispatches the autonomous driving vehicle 20 corresponding to the first automatic path L2 with shortest route.

In step S1106, when the first manual path with shortest route is no longer than the first automatic path with shortest route by the second threshold, the manual driving vehicle corresponding to the first manual path with shortest route is dispatched. It is understandable that when the first manual path L1 with shortest route is longer than the first automatic path L2 with shortest route, but the route difference is less than 3 km, or when the first manual path L1 with shortest route is shorter than the first automatic path L2 with shortest route, the main control device 31 dispatches the manual driving vehicle 10 corresponding to the first manual path L1 with shortest route. Due to the limitation of traffic regulations, speed of the autonomous driving vehicles 20 is generally lower than that of the manual driving vehicles 10. Therefore, even if the first manual path L1 with shortest route is longer than the first automatic path L2 with shortest route, and the route difference is not more than 3 km, it is considered that the manual driving vehicle 10 can drive faster from the starting position A to the end position B than the autonomous driving vehicle 20. Therefore, in this case, dispatch the manual driving vehicle 10 prior.

In the above embodiment, when the time required for the autonomous driving vehicle and the manual driving vehicle to drive from the starting position to the end position is the same, dispatching the autonomous driving vehicle or the manual driving vehicle is determined according to the route of the autonomous driving vehicle and the manual driving vehicle from the starting position to the end position. When the first manual path with shortest route is longer than the first automatic path with shortest route, and exceeds the second threshold, it indicates that the route from the starting position to the end position of the manual driving vehicle is much longer than that of the autonomous driving vehicle, so the autonomous driving vehicle is dispatched. Due to the limitation of traffic regulations, the driving speed of the autonomous driving vehicles is generally lower than that of the manual driving vehicles. When the first manual path with shortest route is longer than the first automatic path with shortest route, but does not exceed the second threshold, it is considered that the manual driving vehicle can drive faster from the starting position to the end position than the autonomous driving vehicle. Therefore, the scheduling of manual driving vehicle is better, so as to improve the customers' riding experience. When the first manual path with shortest route is shorter than the first automatic path with shortest route, the scheduling of manual driving vehicles is better.

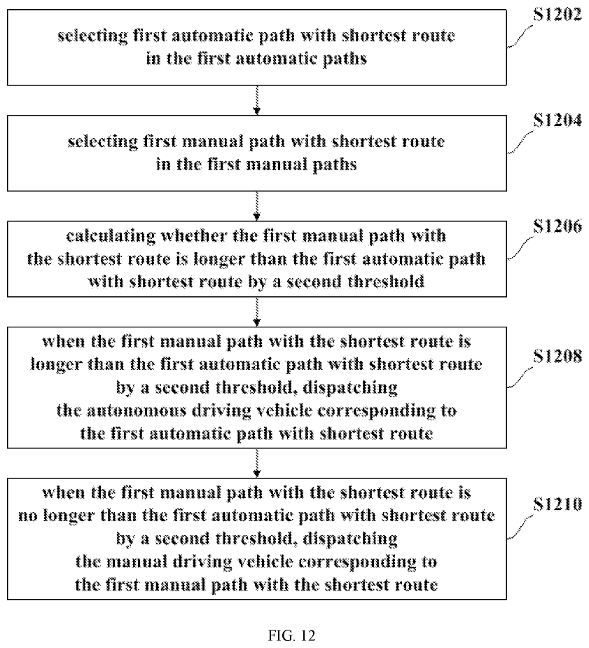

Referring to FIG. 12, FIG. 12 illustrates a sub flow diagram of a vehicle scheduling method in accordance with a fifth embodiment. The difference between the vehicle scheduling method provided by the fifth embodiment and the vehicle scheduling method provided by the first embodiment is that in step S110, the second scheduling rule is selected to dispatch the autonomous driving vehicles or the manual driving vehicles includes the following steps.

In step S1202, first automatic path with shortest route in the first automatic paths is selected. This disclosure uses the main control device 31 to select the first automatic path with shortest route among the planned first automatic paths L2.

In step S1204, first manual path with shortest route in the first manual paths is selected. This disclosure uses the main control device 31 to select the first manual path with shortest route among the planned first manual paths L1.

In step S1206, whether the first manual path with the shortest route is longer than the first automatic path with shortest route by a second threshold is calculated. Preferably, the second threshold is 3 km.

In step S1208, when the first manual path with the shortest route is longer than the first automatic path with shortest route by a second threshold, the autonomous driving vehicle corresponding to the first automatic path with shortest route is dispatched. It is understandable that when the first manual path L1 with shortest route is longer than the first automatic path L2 with shortest route, and the route difference is greater than or equal to 3 km, the main control device 31 dispatches the autonomous driving vehicle 20 corresponding to the first automatic path L2 with shortest route.

In step S1210, when the first manual path with the shortest route is no longer than the first automatic path with shortest route by a second threshold, the manual driving vehicle corresponding to the first manual path with the shortest route is dispatched. It is understandable that when the first manual path L1 with shortest route is longer than the first automatic path L2 with shortest route, but the route difference is less than 3 km, or when the first manual path L1 with shortest route is shorter than the first automatic path L2 with shortest route, the main control device 31 dispatches the manual driving vehicle 10 corresponding to the first manual path L1 with shortest route. Due to the limitation of traffic regulations, speed of the autonomous driving vehicles 20 is generally lower than that of the manual driving vehicles 10. Therefore, even if the first manual path L1 with shortest route is longer than the first automatic path L2 with shortest route, and the route difference is not more than 3 km, it is considered that the manual driving vehicle 10 can drive faster from the starting position A to the end position B than the autonomous driving vehicle 20. Therefore, in this case, dispatch the manual driving vehicle 10 prior.

In some embodiments, when the first manual path L1 with shortest route is longer than the first automatic path L2 with shortest route, and the route difference is equal to 3 km, dispatching the autonomous driving vehicle or the manual driving vehicle can be further determined according to the third driving time and the second driving time.

In the above embodiment, when it is determined that the time difference between the time of current moment and the departure time is greater than the first preset time, that is, the customers arrange the trips in advance through the clients, scheduling is carried out according to the route of the autonomous driving vehicle and the manual driving vehicle from the starting position to the end position, which greatly improves the customers' riding experience.

Referring to FIG. 18, FIG. 18 illustrates a schematic diagram of a main control device in accordance with an embodiment. The main control device 31 includes a processor 311 and a memory 312. In this embodiment, the memory 312 is configured to store program instructions. The processor 311 is configured to execute the program instructions to perform the vehicle scheduling method.

The processor 311, in some embodiments, may be a Central Processing Unit (CPU), controller, microcontroller, microprocessor, or other data processing chip used to run the program instructions stored in the memory 312.

The memory 312 includes at least one type of readable storage medium, which includes flash memory, hard disk, multimedia card, card-type memory (for example, SD or DX memory, etc.), magnetic memory, disk, optical disc, etc. Memory 312 in some embodiments may be an internal storage unit of a computer device, such as a hard disk of a computer device. Memory 312, in other embodiments, can also be a storage device for external computer devices, such as a plug-in hard disk, a Smart Media Card (SMC), a Secure Digital (SD) Card, a Flash Card, etc. equipped on a computer device. Further, the memory 312 may include both the internal and external storage units of a computer device. The memory 312 can not only be used to store the application software and all kinds of data installed in the computer equipment, such as the code to realize the vehicle scheduling method, but also can be used to temporarily store the data that has been output or will be output.

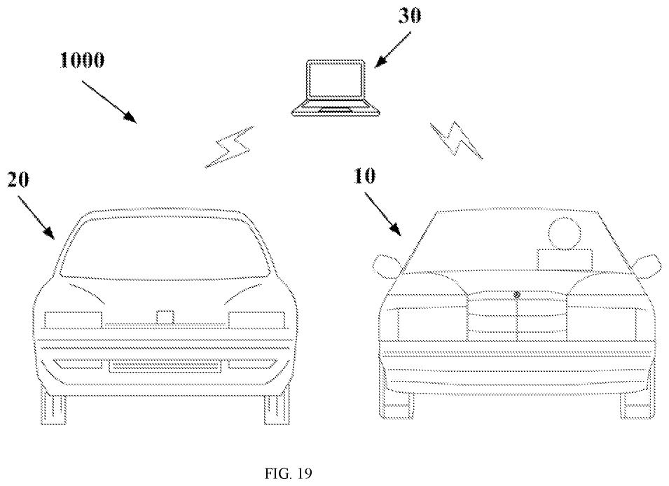

Referring to FIG. 19, FIG. 19 illustrates a schematic diagram of a vehicle scheduling system in accordance with the embodiment. A vehicle scheduling system 1000 includes the manual driving vehicles 10, the autonomous driving vehicles 20, and a vehicle scheduling platform 30. The vehicle scheduling platform 30 is connected with the manual driving vehicles 10 and the autonomous driving vehicles 20. The vehicle scheduling platform 30 may, but is not limited to electronic devices such as desktops, laptops, tablets, etc. In this embodiment, the vehicle scheduling platform 30 includes the main control device 31, and specific structure of the main control device 31 refers to the above embodiments. Since the vehicle scheduling system 1000 adopts all the technical schemes of all the above embodiments, it has at least all the beneficial effects brought by the technical schemes of the above embodiments.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A vehicle scheduling method, comprising:
obtaining reservation information that includes a starting position, an end position, and a departure time;
planning a number of first paths according to the starting position and the end position;
determining whether at least one of the first paths is fully displayed on high-precision map;
when the first paths are not fully displayed on the high-precision map, dispatching manual driving vehicles; and
when at least one of the first paths is fully displayed on the high-precision map, dispatching autonomous driving vehicles or the manual driving vehicles according to corresponding scheduling rules selected by the departure time.

2. The method as claimed in claim 1, wherein the scheduling rules include a first scheduling rule and a second scheduling rule, dispatching autonomous driving vehicles or the manual driving vehicles according to corresponding scheduling rules selected by the departure time comprises:
obtaining time of current moment;
calculating time difference between the time of current moment and the departure time;
determining whether the time difference is less than or equal to first preset time;
when the time difference is less than or equal to the first preset time, selecting the first scheduling rule to dispatch the autonomous driving vehicles or the manual driving vehicles; and
when the time difference is greater than the first preset time, selecting the second scheduling rule to dispatch the autonomous driving vehicles or the manual driving vehicles.

3. The method as claimed in claim 2, wherein selecting the first scheduling rule to dispatch the autonomous driving vehicles or the manual driving vehicles comprises:
determining whether there are idle vehicles within a first preset range;
when there are idle vehicles within the first preset range, obtaining types of the idle vehicles, the types of the idle vehicles include autonomous driving vehicle and manual driving vehicle;
determining whether all the idle vehicles are manual driving vehicles;
when all the idle vehicles are manual driving vehicles, dispatching the manual driving vehicles;
when all the idle vehicles are not manual driving vehicles, dispatching the autonomous driving vehicles according to a first sub rule; and
when the idle vehicles include the autonomous driving vehicle and the manual driving vehicle, dispatching the autonomous driving vehicles or the manual driving vehicles according to a second sub rule.

4. The method as claimed in claim 3, wherein dispatching the autonomous driving vehicles according to a first sub rule comprises:
obtaining first current positions of the autonomous driving vehicles;
planning second paths according to the first current positions and the starting position;
determining whether at least one of the second paths is fully displayed on the high-precision map;
when a second path is fully displayed on the high-precision map, dispatching the autonomous driving vehicle corresponding to the second path fully displayed on the high-precision map;
when more than one of the second paths are fully displayed on the high precision map, obtaining a second path with shortest route in the second paths; and
dispatching corresponding autonomous driving vehicle according to the second path with shortest route.

5. The method as claimed in claim 4, wherein dispatching the autonomous driving vehicles according to a first sub rule also comprises:
when the second paths are not fully displayed on the high-precision map, determining whether there are idle vehicles within a second preset range, the second preset range is larger than the first preset range.

6. The method as claimed in claim 3, wherein dispatching the autonomous driving vehicles or the manual driving vehicles according to a second sub rule comprises:
obtaining the first current positions of the autonomous driving vehicles;
planning the second paths according to the first current positions and the starting position;
obtaining schedulable vehicles among the autonomous driving vehicles according to the second paths;
obtaining second current positions of the manual driving vehicles;
planning third paths according to the second current positions and the starting position;
obtaining a path with shortest route in the second paths of the schedulable vehicles and the third paths;
when the path with shortest route is the second path, dispatching the schedulable vehicle corresponding to second path with shortest route; and
when the path with shortest route is the third path, dispatching the manual driving vehicle corresponding to third path with shortest route.

7. The method as claimed in claim 6, wherein obtaining schedulable vehicles among the autonomous driving vehicles according to the second paths comprises:
determining whether the second paths are fully displayed on the high-precision map; and
when the second paths are fully displayed on the high-precision map, selecting the autonomous driving vehicles corresponding to the second paths fully displayed on the high-precision map as the schedulable vehicles.

8. The method as claimed in claim 6, wherein the first paths include first automatic paths suitable for the autonomous driving vehicles and first manual paths suitable for the manual driving vehicles, dispatching the autonomous driving vehicles or the manual driving vehicles according to a second sub rule also comprises:
selecting first manual path with shortest route in the first manual paths;
determining whether routes of the first automatic paths are longer than route of the first manual path with shortest route by a first threshold; and
when the routes of the first automatic paths are longer than route of the first manual path with shortest route by the first threshold, dispatching the manual driving vehicles corresponding to the first manual path with shortest route.

9. The method as claimed in claim 6, wherein the first paths include first automatic paths suitable for the autonomous driving vehicles and first manual paths suitable for the manual driving vehicles, dispatching the autonomous driving vehicles or the manual driving vehicles according to a second sub rule also comprises:
calculating first driving time according to the first automatic paths;
selecting first manual path with shortest route in the first manual paths;
calculating second driving time according to the first manual path with shortest route;
determining whether the first driving time is greater than the second driving time by second preset time; and
when the first driving time is greater than the second driving time by the second preset time, dispatching the manual driving vehicle corresponding to the first manual path with shortest route.

10. The method as claimed in claim 6, wherein the first paths include first automatic paths suitable for the autonomous driving vehicles and first manual paths suitable for the manual driving vehicles, dispatching the autonomous driving vehicles or the manual driving vehicles according to a second sub rule also comprises:
determining whether road condition of the first automatic paths is congested according to a prior knowledge;
when the road condition of the first automatic paths is congested, selecting first manual path with shortest route in the first manual paths; and
dispatching the manual driving vehicle corresponding to the first manual path with shortest route.

11. The method as claimed in claim 3, wherein selecting the first scheduling rule to dispatch the autonomous driving vehicles or the manual driving vehicles also comprises:
when there are no idle vehicles exist within the first preset range, determining whether there are idle vehicles within the second preset range, the second preset range is larger than the first preset range.

12. The method as claimed in claim 2, wherein the first paths include first automatic paths suitable for the autonomous driving vehicles and first manual paths suitable for the manual driving vehicles, selecting the second scheduling rule to dispatch the autonomous driving vehicles or the manual driving vehicles comprises:
selecting first automatic path with shortest route in the first automatic paths;
calculating third driving time according to the first automatic path with shortest route;
selecting first manual path with shortest route in the first manual paths;
calculating second driving time according to the first manual path with shortest route;
determining whether the third driving time is greater than the second driving time;
when the third driving time is greater than the second driving time, dispatching the manual driving vehicle corresponding to the first automatic path with shortest route;
when the third driving time is less than the second driving time, dispatching the autonomous driving vehicle corresponding to the first manual path with shortest route; and
when the third driving time is equal to the second driving time, dispatching the autonomous driving vehicles or the manual driving vehicles according to third sub rule.

13. The method as claimed in claim 12, wherein dispatching the manual driving vehicle corresponding to the first automatic path with shortest route comprises:
determining whether the time difference is equal to the second preset time, the second preset time is less than the first preset time;
when the time difference is equal to the second preset time, obtaining the second current positions of idle manual driving vehicles;
planning third paths according to the second current position and the starting position;
obtaining third path with shortest route in the third paths; and
dispatching the manual driving vehicle corresponding to the third path with shortest route.

14. The method as claimed in claim 12, wherein dispatching the autonomous driving vehicle corresponding to the first manual path with shortest route comprises:
determining whether the time difference is equal to the second preset time, the second preset time is less than the first preset time;
when the time difference is equal to the second preset time, obtaining the first current positions of idle autonomous driving vehicles;
planning the second paths according to the first current positions and the starting position;
obtaining second path with shortest route in the second paths; and
dispatching the autonomous driving vehicle corresponding to the second path with shortest route.

15. The method as claimed in claim 12, wherein dispatching the autonomous driving vehicles or the manual driving vehicles according to third sub rule comprises:
calculating whether first manual path with shortest route is longer than first automatic path with shortest route by a second threshold;
when the first manual path with shortest route is longer than the first automatic path with shortest route by the second threshold, dispatching the autonomous driving vehicle corresponding to the first automatic path with shortest route; and
when the first manual path with shortest route is no longer than the first automatic path with shortest route by the second threshold, dispatching the manual driving vehicle corresponding to the first manual path with shortest route.

16. The method as claimed in claim 2, wherein the first paths include first automatic paths suitable for the autonomous driving vehicles and first manual paths suitable for the manual driving vehicles, selecting the second scheduling rule to dispatch the autonomous driving vehicles or the manual driving vehicles comprises:
selecting first automatic path with shortest route in the first automatic paths;
selecting first manual path with shortest route in the first manual paths;
calculating whether the first manual path with the shortest route is longer than the first automatic path with shortest route by a second threshold;
when the first manual path with the shortest route is longer than the first automatic path with shortest route by a second threshold, dispatching the autonomous driving vehicle corresponding to the first automatic path with shortest route; and
when the first manual path with the shortest route is no longer than the first automatic path with shortest route by a second threshold, dispatching the manual driving vehicle corresponding to the first manual path with the shortest route.

17. The method as claimed in claim 13, wherein dispatching the manual driving vehicle corresponding to the first manual path with the shortest route comprises:
stopping the manual driving vehicles at the second current position;
calculating fourth travel time according to the third path with shortest route; and
dispatching the manual driving vehicles according to the fourth driving time, the time of current moment, and the departure time.

18. The method as claimed in claim 14, wherein dispatching the autonomous driving vehicle corresponding to the first automatic path with shortest route comprises:
controlling the autonomous driving vehicles stop at the first current position;
calculating fifth travel time according to the second path with shortest route; and
dispatching the autonomous driving vehicles according to the fifth driving time, the time of current moment, and the departure time.

19. A main control device, comprising:
a memory configured to store program instructions; and
a processor configured to execute the program instructions to perform a vehicle scheduling method, wherein the method comprising:
obtaining reservation information that includes a starting position, an end position, and a departure time;
planning a number of first paths according to the starting position and the end position;
determining whether at least one of the first paths is fully displayed on high-precision map;
when the first paths are not fully displayed on the high-precision map, dispatching manual driving vehicles; and
when at least one of the first paths is fully displayed on the high-precision map, dispatching autonomous driving vehicles or the manual driving vehicles according to corresponding scheduling rules selected by the departure time.

20. A vehicle scheduling system, comprising:
manual driving vehicles;
automatic driving vehicles; and
a vehicle scheduling platform, the vehicle scheduling platform comprises a main control device, the main control device comprising:
a memory configured to store program instructions; and
a processor configured to execute the program instructions to perform a vehicle scheduling method, wherein the method comprising:
obtaining reservation information that includes a starting position, an end position, and a departure time;
planning a number of first paths according to the starting position and the end position;
determining whether at least one of the first paths is fully displayed on high-precision map;
when the first paths are not fully displayed on the high-precision map, dispatching manual driving vehicles; and
when at least one of the first paths is fully displayed on the high-precision map, dispatching autonomous driving vehicles or the manual driving vehicles according to corresponding scheduling rules selected by the departure time.
